(19) United States
(12) Patent Application Publication
(10) Pub. No.: US 2010/0062750 A1
(43) Pub. Date: Mar. 11, 2010

(54) Method and Apparatus for Transferring Data

(75) Inventors: Jukka Kalevi Nurminen, Espoo (FI); Janne Esa Petteri Noyranen, Helsinki (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/208,125

(22) Filed: Sep. 10, 2008

(51) Int. Cl. H04M 3/42

(52) U.S. Cl. 455/414.2

(57) ABSTRACT

In accordance with an example embodiment of the present invention, an apparatus, comprises a call listener module configured to detect a mobile communication. Further, the apparatus comprises a processor configured to activate a transfer in response to the mobile communication being detected and transfer data, the data not associated with the mobile communication.

### TECHNICAL FIELD

The present application relates generally to transferring data.

### BACKGROUND

Electronic devices are used for many different applications. As such, applications for electronic devices are increasing in number. In many cases, these applications may include an update feature which transfers data. As such, applications are updated by transferring data.

### SUMMARY

Various aspects of the invention are set out in the claims.

In accordance with an example embodiment of the present invention, an apparatus, comprises a call listener module configured to detect a mobile communication. Further, the apparatus comprises a processor configured to activate a transfer in response to the mobile communication being detected and transfer data, the data not associated with the mobile communication.

In accordance with another example embodiment of the present invention, a method comprises detecting a mobile communication. Further, the method comprises activating a transfer in response to the mobile communication being detected and transferring data, the data not associated with the mobile communication.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting a network for transferring data in accordance with an example embodiment of the invention;

FIG. 2 is a block diagram depicting operation of an electronic device in accordance with an example embodiment of the invention;

FIG. 3A is a flow diagram depicting an example method for transferring data in accordance with an example embodiment of the invention;

FIG. 3B is a flow diagram depicting another example method for transferring data in accordance with an example embodiment of the invention; and

FIG. 4 is a block diagram depicting a network for transferring data in accordance with an example embodiment of the invention.

### DETAILED DESCRIPTION OF THE DRAWINGS

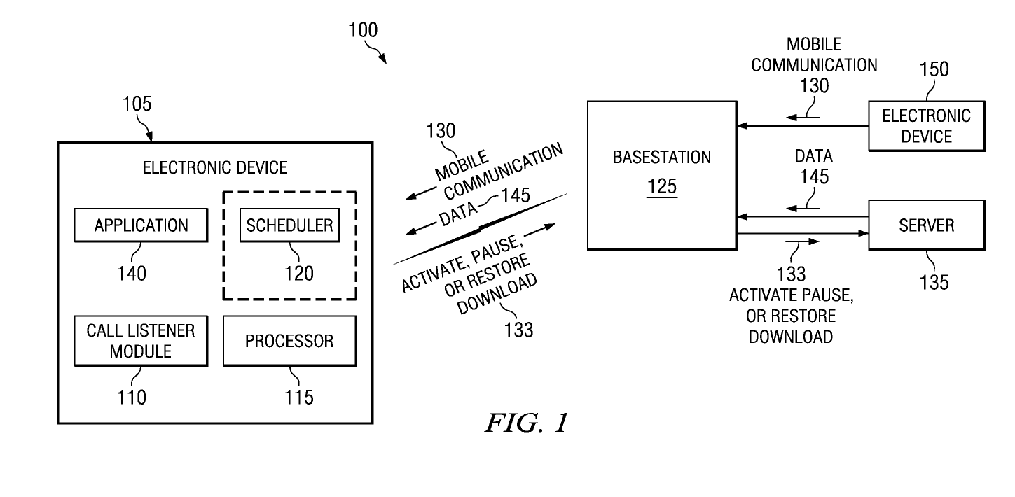

An example embodiment of the present invention and its potential advantages are best understood by referring to FIGS. 1 through 4 of the drawings.

In accordance with an example embodiment, an electronic device may transfer, e.g., upload, download, and/or the like data without using much additional power during a voice call. An embodiment of the invention may facilitate transferring data, e.g. podcasts, video episodes, updates, photos, emails, calendar events, calendar data, phonebook data, audio, video, and/or the like during a voice call. In an embodiment, transferring data with no voice call may use additional power to transfer data as opposed to transferring data during a voice call. Thus, transferring data during a voice call conserves power.

FIG. 1 is a block diagram depicting a network 100 for transferring data 145 in accordance with an example embodiment of the invention. In this example embodiment, an electronic device 105 may be in communication with a basestation 125. The basestation 125 may be in communication with an electronic device 150 and/or a server 135. Further, the electronic device 105 may comprise a call listener module 110, a processor 115, an application 140, a scheduler 120, and/or the like. In an embodiment, the application 140 may be a video center, a podcast application, an image sharing application, an email client, a calendar client, a really simple syndication (RSS) reader, and/or the like.

In an embodiment, the electronic device 105 may communicate using a wireless network that may be a wireless personal area network (WPAN) operating, for example, under the Bluetooth or IEEE 802.15 network protocol. The wireless network may be a wireless local area network (WLAN) operating, for example under the IEEE 802.11, Hiperlan, WiMedia Ultra Wide Band (UWB), WiMax, WiFi, or Digital Enhanced Cordless Telecommunications (DECT) network protocol. Or, the wireless network may be a wireless wide area network (WWAN) operating, for example, under a cellular telephone network protocol, for example Global System for Mobile (GSM), General Packet Radio Service (GPRS), Enhanced Data rates for GSM Evolution (EDGE), Global Positioning System (GPS), Code Division Multiple Access (CDMA), Universal Mobile Telecommunications System (UMTS), CDMA2000 and/or the like.

In an embodiment, the call listener module 110 may be configured to detect an initiation of a mobile communication, such as a new voice call, between the electronic device 105 and the electronic device 150. For example, the call listener module 110 may detect or otherwise identify a voice call, e.g., mobile communication 130, between the electronic device 105 and the electronic device 150, via the basestation 125. In an embodiment, the call listener module 110 may listen for a voice call by opening a connection to a port typically associated with receiving a voice call. In an alternative embodiment, the call listener module 110 may identify an event from an operating system, e.g., Symbian, of a call initiation. It should be understood that the call listener module 110 may also use other techniques known in the art for identifying the mobile communication 130.

In an embodiment, the electronic device 105 may transfer or initiate transfer of data 145, for example, during mobile communication 130. The electronic device 105 may comprise a processor 115 configured to activate a transfer of data 145, such as a software update. In an example embodiment, activation of data transfer is performed in response to the mobile communication being detected. The processor 115 may also transfer the data 145. In an embodiment, transfer of data 145 may comprise uploading data, downloading data, a combination thereof, and/or the like. In an embodiment, the transfer of data 145 may occur during the mobile communication 130. In an embodiment, the data 145 being transferred or to be transferred may not be associated with the mobile communication 130. Instead, the data 145 may be associated with the application 140. In an embodiment, the data 145 may be related to the mobile communication 130. In an alternative embodiment, the data 145 may not be related to the mobile communication 130. For example, the processor 115 of the electronic device 105 may activate transferring of a software update for the application 140. In an alternative embodiment, the data 145 may be associated with the mobile communication 130 and/or the application 140 and transferred during a voice call.

In an embodiment, the processor 115 may be configured to transfer the data 145 from the basestation 125, via the server 135, e.g., an application server, during a voice call. In an alternative embodiment, the processor 115 may be configured to transfer the data 145, from a really simple syndication (RSS) feed. In an embodiment, a RSS feed may be a really simple syndication reader, rich summary site reader, resource description framework (RDF) summary site reader, and/or the like. Further, RSS may be a family of Web feed formats used to publish frequently updated content such as blog entries, news headlines, podcasts in a standardized format and/or the like. An RSS document, e.g., a feed, a web feed, a channel, and/or the like, may contain either a summary of content from an associated web site, the full text, and/or the like. One benefit of using RSS may be the aggregation of RSS content from one or more web sources in one location. In yet another embodiment, the processor 115 may be configured to transfer the data 145, from a second electronic device, such as electronic device 150. For example, the electronic device 105 may be in communication with a second electronic device and the second electronic device may send data to the electronic device 105. Restated, a user of one of the electronic devices may transfer an audio, video, and/or the like, during a voice call, e.g., a conversation to the other electronic device.

In an embodiment, the electronic device 105 may read the RSS content by using an RSS reader, a feed reader, an aggregator and/or the like. Further, the processor 115 of the electronic device 105 may activate transferring of the RSS content. In an embodiment, the processor 115 may be configured to receive the RSS content, e.g., data 145, from an Internet feed during a voice call. By transferring the data 145 during a voice call as opposed to having a separate data 145 transfers, the electronic device 105 decreases the power usage of the electronic device 105. Consider the following example. The electronic device 105 may comprise a RSS reader for a podcast. The processor 115 may transfer the RSS content from an Internet feed during a voice call. Thus, the RSS content is transferred to the podcast during the voice call, e.g., mobile communication 130, and as such conserves power usage of the electronic device 105.

In an embodiment, the mobile communication 130 may terminate before the transfer of data 145 is complete. In such an embodiment, the call listener module 110 may be configured to detect a termination of the mobile communication 130. The processor 115 may be configured to deactivate the transfer when the mobile communication terminates. Further, the processor 115 may also be configured to pause the transfer 133 or restore a paused transfer. For example, the processor 115 may pause the transfer 133 of data 145 at a termination of the mobile communication 130. If the call listener module 110 detects another mobile communication 130, e.g., a voice call, the processor 115 may restore the paused transfer of data 145. In an alternative embodiment, the electronic device 105 may optionally comprise a scheduler 120, as described below, to schedule data 145 transfers.

It should be understood that the data 145 may be from a server, a hypertext transfer protocol, a video center, a podcast, an image sharing application, an email client, a calendar client, a really simple syndication (RSS) reader, a rich summary site reader, a resource description framework summary site reader, and/or the like. Further, the data 145 may also be data for or from a widget update, a software upgrade for mobile application, a firmware upgrade, a Peer-to-Peer transfer, an address book update, a currency converter application, a browser for pre-loading content, clock synchronization, a map or map data, a catalog, a network backup, a lifeblog update, a blog update, and/or the like.

Electronic device 105 may be any device in the entire gamut of consumer electronics including, but not limited to, a mobile telephone, a personal digital assistant, a portable computer device, a GPS device, a GPS navigation device, a GPS system, a mobile computer, a camera, a browsing device, an electronic book reader, a combination thereof, and/or the like.

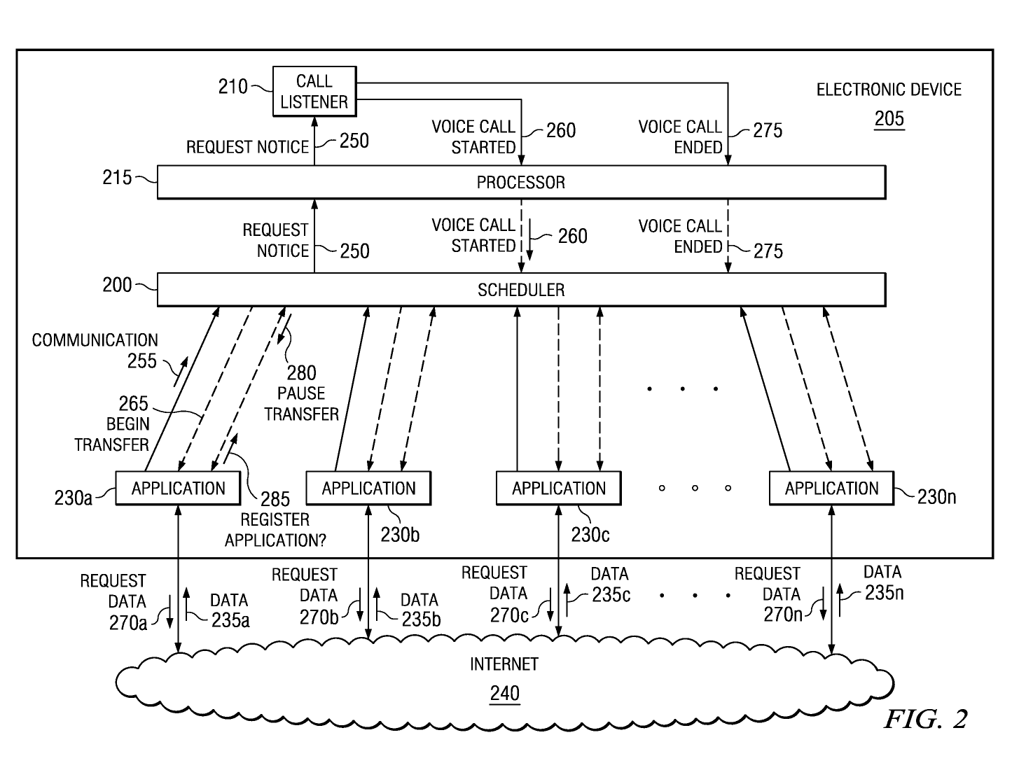

FIG. 2 is a block diagram depicting operation of an electronic device 205 in accordance with an example embodiment of the invention. In this example embodiment, the electronic device 205 may be in communication with a basestation, a server, another electronic device, and/or the like via Internet 240. The electronic device 205 may comprise a call listener module 210, a processor 215, one or more applications 230a-n, and/or a scheduler 200. In an embodiment, a mechanism, such as the processor 215, may be used to transfer data, such as data 235a-n. In an example embodiment, electronic device 205 is similar to electronic device 105, scheduler 200 is similar to scheduler 120, call listener 210 is similar to call listener 110, processor 215 is similar to processor 115, each of applications 230a-n are similar to application 145. In an alternative embodiment, electronic device 205, call listener 210, processor 215, and applications 230a-n may be different than electronic device 105, call listener 110, processor 115, and application 145.

In this example embodiment, the scheduler 200 may request notice 250, e.g., register, with the call listener 210 to determine whether to activate a transfer of data, for example, in response to a mobile communication being detected. The call listener 210 may provide notice 260 indicating a voice call initiation to the scheduler 200. For example, the call listener 210 may send a voice call initiated message 260 or otherwise notify the scheduler 200 of a voice call initiation. The voice call initiated message 260, for example, may indicate a voice call has started. In an embodiment, the scheduler 200 may provide a carrier identifier to the application 230a. The carrier identifier may be used by the application 230a as a radio signal or the like to transfer data over the radio signal. Further, the scheduler 200 may receive the communication 255 from an application 230a to register the application for a transfer of data 235a, e.g., queue the transfer of data. In an alternative embodiment, the scheduler 200 may determine that the application 230a has a paused transfer. In this example, the scheduler 200 may restore the paused transfer. In an embodiment, the scheduler 200 may determine which applications comprise a paused transfer based on the communication 255. In this embodiment, the scheduler 200 may use an application programming interface (API) to communicate between the applications 235a-n. It should be understood that the transfer of data may be for multiple applications, such as applications 230a-n.

In an embodiment, an API may be a set of declarations of the functions or procedures that an operating system, library or service provides to support requests or communications, such as communication 255. In an embodiment, the scheduler 200 may use a call back function to communicate with the application 230a. For example, the scheduler 200 may perform a call back to the application 230a to identify what data to transfer. The application 230a may be configured to determine what data to transfer. Further, the application 230a may communicate, e.g., via the call back, the data to transfer to the scheduler 200. In an embodiment, the call back may be executable code that is passed as an argument to other code. Thus, in an example embodiment, the call back function allows a lower-level software layer to call a subroutine or function defined in a higher-level layer. In an embodiment, the higher-level code may start by calling a function within the lower-level code and pass a pointer or handle to another function. While the lower-level function executes, the lower-level function may call the passed-in function any number of times to perform some subtask, e.g., activate a transfer.

Continuing with FIG. 2, the scheduler 200 may activate the transfer, for example, in response to the mobile communication being detected. Further, the application 230a may request data 270a from a server and/or the like via, for example, Internet 240 to obtain the data 235a. For example, when a voice call begins, the scheduler 200 may activate the transfer and application 230a may refresh a RSS feed and start or restore a transfer for a podcast. In an embodiment, while the transfer of data is ongoing, the scheduler 200 may receive a notice 275, for example from call listener 210, that the voice call terminated. The scheduler may notify the application 230a to pause or otherwise deactivate the transfer of data 235a. The application 230a may send a new communication 285 to the scheduler 200, for example, to register the application 230a, remove the previous communication 255 or registration, or not respond. In an example embodiment, if the application 230a does not respond, the scheduler 200 may restore the paused transfer during a new voice call. If the application 230a responds, then in an example embodiment, the scheduler 200 may transfer data 235a using the new communication 285 from the application 230a.

In an example embodiment, a podcast application may support automatic transfers for periodic transferring, such as every 15 or 60 minutes, twice/once a day, and/or the like. In this example embodiment, the scheduler 200 may activate a transfer based at least in part on the periodic transferring. The application 230a may receive the data 235a via the Internet 240 thereby beginning the transfer.

In an alternative embodiment, a scheduler 200 may receive a communication from an application 230a to register the application 230a. The communication may comprise an identification of data to transfer, a time deadline, and/or the like. The scheduler 200 may use a time deadline to activate a transfer for the application 230a without a voice call. For example, it may be desirable for the application 230a to be updated within 12 hours of the communication. In this example, the application 230a may send the communication to the scheduler 200 indicating a time deadline of 12 hours. If a voice call is initiated, the scheduler 200 may initiate the transfer from a server and/or other data source. If the transfer is not complete by the time deadline, e.g., 12 hours, the scheduler 200 may initiate or complete the transfer, e.g., based at least in part on the time deadline for the application 230a, regardless of whether a voice call is in progress or not. In an embodiment, the scheduler 200 may also use a call back function to the application 230a to determine or identify the data to transfer.

In an embodiment, the scheduler 200 may use a minimum deadline and/or maximum deadline to initiate a transfer. For example, the scheduler 200 may not initiate the transfer if the minimum deadline has not been reached. Further, the scheduler 200 may initiate the transfer, during a voice call, if the current time is between the minimum deadline and maximum deadline. Further still, the scheduler 200 may initiate the transfer without a voice call if the maximum deadline is reached.

The example embodiment depicts using a processor 215 for communicating between the call listener 210 and the scheduler 200. It should be understood that in an alternative embodiment the call listener 210 and the scheduler 200 may receive notification of a voice call, e.g., an event notification, from an operating system, such as Symbian. Use of other operating systems is also possible.

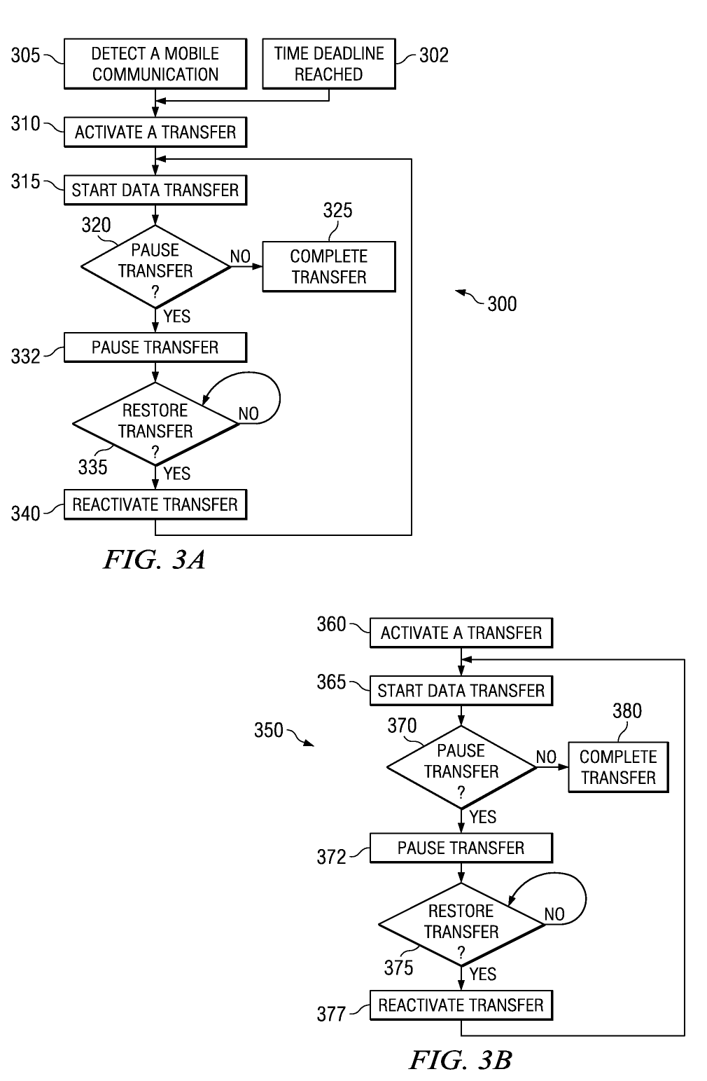

FIG. 3A is a flow diagram depicting an example method for transferring data in accordance with an example embodiment of the invention. Example method 300 may be performed by an electronic device, such as electronic device 105 of FIG. 1. In an example embodiment, a mobile communication may be detected at 305. For example, the electronic device may detect an initiation of a voice call. The initiation of the voice call may be to or from the electronic device. In an alternative embodiment, a time deadline for transferring data may be reached at 302. At 310, a transfer of data may be activated, for example, in response to a mobile communication being detected. For example, the electronic device 302 may activate a transfer of data from a server, for example server 135 of FIG. 1, if a voice call has been detected.

In an embodiment, the data may be related to at least one of the following: a video center, a podcast, an image sharing application, an email client, a calendar client, hypertext transfer protocol, a Really Simple Syndication reader, Rich Summary Site reader, Resource Description Framework Summary Site reader, and/or the like. In an example embodiment, a podcast is a series of digital-media files which are distributed over the Internet using syndication feeds for playback on portable media players and/or computers. Further, a podcast may also refer either to the series of content itself or to a syndication technique. In an embodiment, the syndication technique may also be referred to as podcasting. In an embodiment, HTTP may be an application-level protocol for distributed, collaborative, hypermedia information systems, and/or the like.

Referring back now to FIG. 3A, at 315 the data transfer may be started. In an example embodiment, the data is not associated with the mobile communication detected at 305. For example, the electronic device may transfer podcast data during a voice call on the electronic device. At 320, it is determined whether the transfer of data is to be paused. For example, the electronic device may pause the transfer of data at a termination of the mobile communication. In an example embodiment, the transfer of data may not be paused if the data transfer was started in response to a time deadline being reached at 302. If at 320 it is determined that the transfer of data is not to be paused, the transfer of data may be completed at 325.

If at 320, it is determined that the transfer of data is to be paused, then at 332 the transfer of data may be paused. In an example embodiment, an application, such application 230a of FIG. 2, may provide a communication that a transfer of data is paused. At 335, it is determined whether the transfer of data is to be restored. In an example embodiment, this determination is made by a mobile communication being detected. In an example embodiment, a scheduler, such as scheduler 200 of FIG. 2 may determine which data to restore based on the communication, such as communication 255, from the application. If the transfer of data is not to be restored, for example because a mobile communication is not ongoing or not being detected, then the process returns to 335. If at 335, it is determined that the transfer is to be restored, for example because a mobile communication is detected, then at 340 the transfer of data is reactivated and the process continues to 315.

FIG. 3B is a flow diagram depicting another example method 350 for transferring data in accordance with an example embodiment of the invention. Example method 350 may be performed by a server, such as server 135 of FIG. 1. At 360, transfer of data may be activated. Transfer of data may be activated, for example, in response to a mobile communication being detected. In an example embodiment, transfer of data may be activated upon receiving a request of data. In this example embodiment, the transfer of data from the server to an electronic device, such as electronic device 105 of FIG. 1, is activated. At 365, the data transfer may be started. For example, the server may transmit data to the electronic device.

At 370, it is determined whether the transfer of data is to be paused. If at 370 it is determined that the transfer of data is not to be paused, the transfer of data may be completed at 380. If at 370, it is determined that the transfer of data is to be paused, then at 372 the transfer of data may be paused. In an example embodiment, an application, such application 230a of FIG. 2, may provide a communication that a transfer of data is paused. For example, the electronic device may pause the transfer of data at a termination of the mobile communication. In an example embodiment, an application, such application 230a of FIG. 2, may provide a communication that a transfer of data is paused. At 375, it is determined whether the transfer of data is to be restored. In an example embodiment, this determination is made by a mobile communication being detected. In an example embodiment, a scheduler, such as scheduler 200 of FIG. 2 may determine which data to restore based on the communication, such as communication 255, from the application. If the transfer of data is not to be restored, for example because a mobile communication is not ongoing or not being detected, then the process returns to 375. If at 375, it is determined that the transfer is to be restored, for example because a mobile communication is detected, then at 377 the transfer of data is reactivated and the process continues to 365.

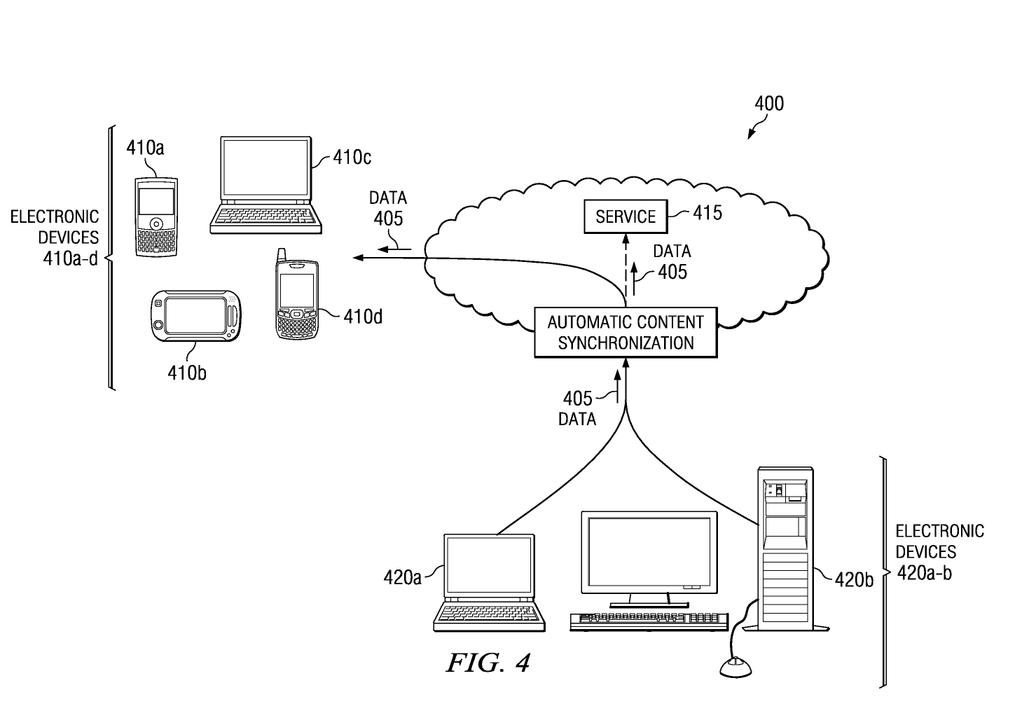

FIG. 4 is a block diagram depicting a network 400 for transferring data 405 in accordance with an example embodiment of the invention. In an example embodiment, a network 400 may comprise one or more electronic devices 410a-d, 420a-b and one or more services 415. In an embodiment, the one or more electronic devices 410a-d, 420a-b and one or more services 415 may be configured to synchronize data 405 between each other. Further, the one or more electronic devices 410a-d, 420a-b, and/or one or more services 415 may employ embodiments of the invention to transfer data 405 for synchronization during a mobile communication to conserve power. For example, during an active mobile communication for electronic device 410a, electronic device 420a may transfer data 405 to electronic device 410a during the mobile communication. In another example, during an active mobile communication for electronic device 410a, electronic device 420a may transfer data 405 to one or more services 415 during the mobile communication. In yet another example, during an active mobile communication, electronic device 410a may transfer data 405 to one or more services 415 during the mobile communication. Thus, the network 400 may transfer data to one or more locations for synchronization or other purposes while obtaining the benefit of conserving power.

Without in any way limiting the scope, interpretation, or application of the claims appearing below, it is possible that a technical effect of one or more of the example embodiments disclosed herein may be conserving power usage for data transfers. Another possible technical effect of one or more of the example embodiments disclosed herein may be adding additional services without effect on battery power. Another possible technical effect of one or more of the example embodiments disclosed herein may be less frequent charging of a battery of an electronic device. Another possible technical effect of one or more of the example embodiments disclosed herein may be less global energy consumption.

Embodiments of the present invention may be implemented in software, hardware, application logic or a combination of software, hardware and application logic. The software, application logic and/or hardware may reside on an electronic device or a server. If desired, part of the software, application logic and/or hardware may reside on an electronic device, and part of the software, application logic and/or hardware may reside in a server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a call listener module configured to detect a mobile communication; and
a processor configured to:
activate a transfer in response to the mobile communication being detected; and
transfer data, the data not associated with the mobile communication.

2. The apparatus of claim 1 wherein the processor is further configured to start the transfer of the data.

3. The apparatus of claim 1 wherein the processor is further configured to pause the transfer.

4. The apparatus of claim 1 wherein the processor is further configured to restore a paused transfer.

5. The apparatus of claim 1 wherein the call listener module is further configured to detect a termination of the mobile communication.

6. The apparatus of claim 1 wherein the processor is further configured to pause the transfer at a termination of the mobile communication.

7. The apparatus of claim 1 further comprising a scheduler configured to:
receive a communication from an application; and
provide a carrier identifier to the application.

8. The apparatus of claim 7 wherein the communication from the application is a time deadline to complete the transfer of data.

9. The apparatus of claim 7 wherein said application is configured to:
determine what data is to be transferred; and
communicate information of the data to be transferred to a scheduler.

10. The apparatus of claim 7 wherein the scheduler is further configured to perform a call back to the application to identify the data to transfer.

11. The apparatus of claim 1 wherein the transfer may use at least one of the following:
code division multiple access, global system for mobile communication, global system for mobile communication global positioning system, or universal mobile telecommunications system.

12. The apparatus of claim 1 wherein the data relates to at least one of the following:
a hypertext transfer protocol, a video center, a podcast, an image sharing application, an email client, a calendar client, a really simple syndication reader, rich summary site reader, or resource description framework summary site reader.

13. The apparatus of claim 1 wherein the transfer is an upload, a download, or a combination thereof.

14. The apparatus of claim 1 wherein the transfer comprises transmission of the data.

15. The apparatus of claim 1 wherein the transfer comprises receipt of the data.

16. The apparatus of claim 1 wherein the data is associated with the mobile communication.

17. A method, comprising:
detecting a mobile communication;
activating a transfer in response to the mobile communication being detected; and
transferring data, the data not associated with the mobile communication.

18. The method of claim 17 further comprising starting the transfer of the data.

19. The method of claim 17 further comprising pausing the transfer.

20. The method of claim 17 further comprising restoring a paused transfer.

21. The method of claim 17 further comprising detecting an termination of the mobile communication.

22. The method of claim 17 further comprising deactivating the transfer at a termination of the mobile communication.

23. The method of claim 17 further comprising:
receiving a communication from an application; and
providing the application with a carrier identifier.

24. The method of claim 23 wherein the communication from the application is a time deadline to complete the transferring of data.

25. The method of claim 23 further comprising:
determining what is data to be transferred; and
communicating information of the data to be transferred.

26. The method of claim 23 further comprising performing a call back to the application to identify the data to transfer.

27. The method of claim 17 wherein the transferring uses at least one of the following:
code division multiple access, global system for mobile communication, global system for mobile communication global positioning system, or universal mobile telecommunications system.

28. The method of claim 17 wherein the data relates to at least one of the following:
a hypertext transfer protocol, a video center, a podcast, an image sharing application, an email client, a calendar client, a really simple syndication reader, rich summary site reader, or resource description framework summary site reader.

29. The method of claim 17 wherein transferring data comprises uploading data, downloading data, or a combination thereof.

30. The method of claim 17 wherein transferring data comprises transmission of the data.

31. The method of claim 17 wherein transferring data comprises receipt of the data.

32. The method of claim 17 wherein the data is associated with the mobile communication.

33. A computer program product comprising a computer-readable medium bearing computer program code embodied therein for use with a computer, the computer program code comprising:
code for detecting a mobile communication;
code for activating a transfer in response to the mobile communication being detected; and
code for transferring data, the data not associated with the mobile communication.

34. A computer-readable medium encoded with instructions that, when executed by a computer, perform:
detecting a mobile communication;
activating a transfer in response to the mobile communication being detected; and
transferring data, the data not associated with the mobile communication.
